(19) United States
(12) Patent Application Publication
(10) Pub. No.: US 2008/0217469 A1
(43) Pub. Date: Sep. 11, 2008

(54) ROTORCRAFT AIR CONDITIONER SYSTEM

(75) Inventors: Claude Houver, Lambesc (FR); Stephane Auribaut, Vitrolles (FR)

Correspondence Address: YOUNG & THOMPSON, 209 Madison Street, Suite 500, ALEXANDRIA, VA, 22314, US

(73) Assignee: EUROCOPTER, MARIGNANE CEDEX (FR)

(21) Appl. No.: 11/851,420

(22) Filed: Sep. 7, 2007

(30) Foreign Application Priority Data
Sep. 8, 2006 (FR) 06/07867

(51) Int. Cl. G05D 23/00; B64D 35/00

(52) U.S. Cl. 244/60; 62/157

(57) ABSTRACT

The invention relates to a method of controlling an air conditioner in a rotorcraft that also includes a cooler for cooling transmission lubricant, in which the temperature of the lubricant is monitored and the capacity of the air conditioner is decreased in the event of the lubricant temperature reaching or exceeding a determined value.

The present invention relates to an air conditioner system for helicopters or other rotorcraft.

The technical field of the invention is that of manufacturing rotorcraft.

### BACKGROUND OF THE INVENTION

The present invention relates more particularly to apparatus for cooling the air in a rotorcraft cabin, to a method and a device for controlling the operation of said apparatus, and to a rotorcraft fitted with such an apparatus and with such a control device.

The invention applies to rotorcraft having a lift and propulsion rotor, an engine for driving the rotor, and a mechanical transmission device, or gearbox, connecting the motor to the rotor, the gearbox being lubricated by a lubricant (such as oil) and being connected to a circuit for cooling the lubricant, said circuit including a heat exchanger for cooling the lubricant by means of ambient air.

It is known to fit a helicopter with an air conditioner in which a refrigerant fluid is subjected to a compression/condensation/expansion/evaporation cycle. Such an air conditioner comprises for this purpose a compressor, a condenser, an expander, and an evaporator connected in that order by ducts for conveying the refrigerant fluid.

U.S. Pat. No. 4,490,989 describes such an air conditioner in which the compressor is driven by the helicopter engine via a pulley-and-belt transmission system.

It is also know to fit the air conditioner of a helicopter with a compressor that is driven by an electric motor, e.g. as described in U.S. Pat. No. 6,155,062.

In the field of motor-driven land vehicles, it is known to fit an air conditioner with a piston compressor having variable cylinder capacity, such as the compressor described in U.S. Pat. No. 6,162,026.

That enables the capacity of the compressor to be adapted as a function of the speed of rotation of the vehicle engine or as a function of the temperature of the engine cooling water, as described in patent FR-2 801 249.

U.S. Pat. No. 4,425,766 describes a system for controlling a fan that blows air over the radiator and the condenser of a vehicle air conditioner.

It is known to place a helicopter air conditioner unit comprising the condenser and the associated fan, together with the compressor, in a compartment or bay for receiving a lateral undercarriage; such a disposition makes it necessary to make provision in that compartment, for an air circuit for the condenser of the air conditioner unit, and for the circuit comprising an air inlet, a duct for conveying air, and an air outlet, thereby occupying a large volume.

### OBJECTS AND SUMMARY OF THE INVENTION

An object of the invention is to remedy that problem.

An object of the invention is to propose an air conditioner, a method, and a device for controlling the air conditioner, and a rotorcraft fitted with said air conditioner and said device, that are improved and/or that remedy, at least in part, the shortcomings or drawbacks of previously known air conditioners, control devices, and rotorcraft.

In one of its aspects, the invention provides placing the condenser of the rotorcraft air conditioner in a duct for conveying external (ambient) air to a heat exchanger/radiator for cooling a lubricant of the transmission (from the rotorcraft engine to the main rotor of the rotorcraft), and fitting the air conditioner (and the rotorcraft) with a control device that favors cooling of the lubricant to the detriment of the performance of the air conditioner, when necessary.

The invention thus makes it possible to reduce the overall volume of the air conditioner since no specific duct is required for conveying air to the condenser.

The invention makes it possible to reduce the weight of the air conditioner since only one fan need be provided that is common both to the condenser and to the lubricant cooler.

The invention makes it possible to guarantee reliability and proper operation in the propulsion of the rotorcraft rotor by ensuring under all circumstances that the lubricant of the transmission mechanism is cooled, even when the ambient (outside) temperature is high.

In one of its aspects, the invention provides a device for controlling the air conditioner, which device is arranged/programmed to reduce the performance/capacity of the air conditioner, where appropriate, in order to maintain the temperature of the lubricant at the outlet from the cooler below a (pre)determined value, e.g. of the order of 90° C. to 100° C., approximately.

Thus, according to another aspect of the invention, there is provided a method of controlling an air conditioner of a rotorcraft including a lubricant cooler for a transmission, in which the temperature of the lubricant is monitored, and the capacity of the air conditioner is decreased in the event of the lubricant temperature reaching or exceeding a determined value.

This method may be implemented by a computer or by an equivalent data processor unit.

Thus, in another aspect of the invention, there is provided a program including code carried by a medium, such as a memory or implemented as a signal, the code being readable and/or executable by a data processor unit, such as a processor, on board a rotorcraft, or suitable for being placed on board a rotorcraft, for the purpose of controlling a rotorcraft air conditioner, the code comprising:
a first code segment, or read module, for reading first data representative of the temperature of a lubricant of a transmission mechanism of the rotorcraft, which temperature is preferably measured at the outlet from a lubricant cooler;
a second code segment, or calculation module, for determining and limiting, as a function of the first data, second data representative of a capacity of the air conditioner (or a capacity/performance ratio setpoint); and
a third code segment, or write module, for recording the second data.

The first data may be the result of converting a signal delivered by a sensor responsive to the temperature of the lubricant leaving the cooler. The second data may be converted into a control signal for controlling (varying) the capacity of the air conditioner.

Limiting the second data as a function of the first data serves to limit the capacity of the air conditioner. As a result, the extent to which the ambient air passing through the condenser is heated is likewise limited, thus making it possible to maintain proper cooling of the lubricant.

The second code segment can determine the second data as a function of target capacity data, said target data itself being determined as a function of setpoint data for the air temperature to be maintained in the rotorcraft and of data representative of the temperature of air as measured in the rotorcraft.

The code, and in particular the second segment of code, may include proportional (P), integral (I), and/or derivative (D) calculation instructions for determining output data as a function of input data, so that the data processor unit incorporates one or more P, PI, or PID regulator modules.

In particular, the code may include a first PID module for determining a temperature setpoint for the lubricant, or a setpoint for the condensation temperature of the refrigerant fluid, as a function of the difference between the setpoint for the air temperature to be maintained in the cabin and a measurement of the cabin air temperature.

The code may include a second PID module for determining the setpoint for the air conditioner capacity, i.e. the speed or the volume swept by the compressor, as a function of the difference between the setpoint for the lubricant temperature to be maintained at the outlet from the cooler (or the condensation temperature) as determined by the first PID module and as a function of a measurement of the actual temperature of the lubricant at the outlet from the cooler.

The cooling capacity of the air conditioner can be varied (limited) by implementing a corresponding variation in the speed at which the air conditioner compressor is driven, in particular when the compressor is driven by an electric motor. In other embodiments, this variation in capacity can be implemented by any other system for regulating capacity and installed on the cooling circuit, such as a valve providing a bypass.

In a preferred embodiment, the air conditioner includes a piston compressor of capacity that is variable as a function of a capacity variation control signal that is delivered by the air conditioner control device.

The variation in capacity may be the result of varying the compressor piston stroke, and/or the cylinder capacity or the volume swept per unit time, without significantly varying the drive speed of the compressor. This variation may be controlled by the signal that results from the second data, and it may be obtained as described in U.S. Pat. No. 6,162,026, for example.

In a preferred embodiment of the invention, the condenser and the heat exchanger are placed on top of the cabin of the rotorcraft, the condenser being placed upstream (relative to the air flow direction) from the cooler heat exchanger, and the fan common to the condenser and the heat exchanger is placed downstream from both of them.

### BRIEF DESCRIPTION OF THE DRAWINGS

Other aspects, characteristics, and advantages of the invention appear in the following description which refers to the accompanying drawings that show preferred embodiments of the invention with no limiting character.

FIG. 1 is a block diagram showing the main components of the air conditioner, the air stream in which the condenser of the air conditioner and the lubrication oil cooler of a main transmission gearbox of the helicopter are located, and modules of apparatus for controlling the air conditioner.

FIG. 2 is a diagram showing the refrigeration fluid circuit of the air conditioner, the connections between the sensors and the actuator, and the connections between the sensors and the air conditioner control device.

FIG. 3 is a diagrammatic side view showing how a condenser and an oil cooler are installed above the cabin of a helicopter.

### MORE DETAILED DESCRIPTION

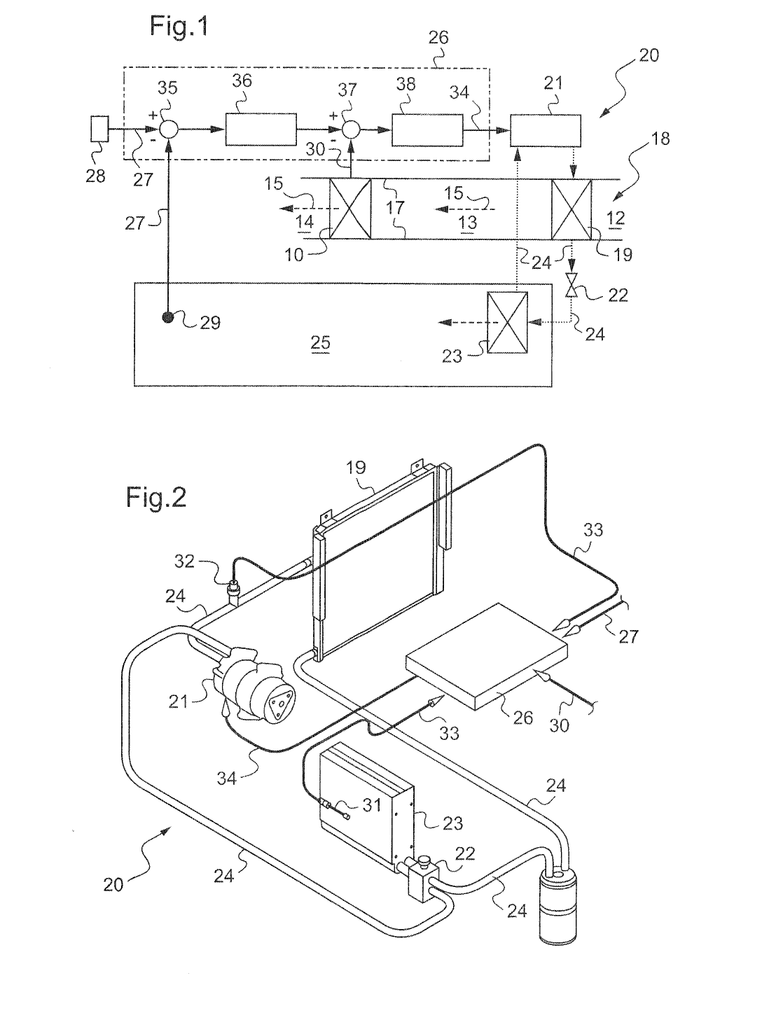

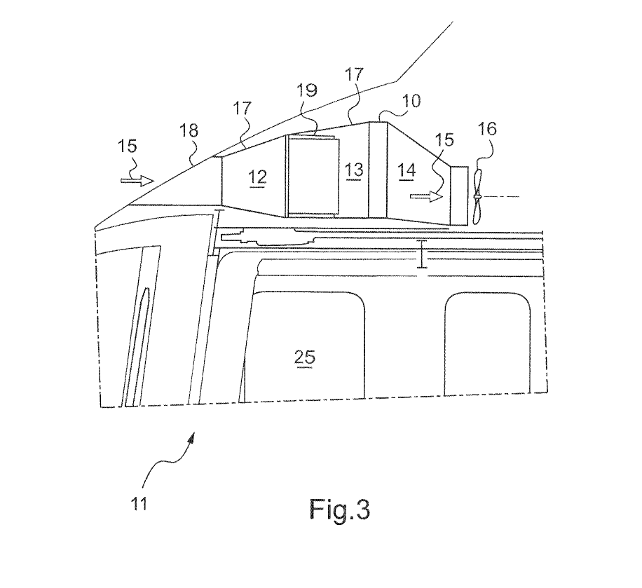

With reference to FIGS. 1 and 3 in particular, the invention applies in particular to rotorcraft having an air/oil heat exchanger 10 for the purpose of cooling the lubrication oil of the main transmission gearbox (not shown) of the rotorcraft 11.

The heat exchanger is placed for this purpose in a duct 12, 13, 14 that is defined by walls 17 and in which air flows, being sucked in by a fan 16 through an air inlet orifice 18 at the upstream end of the duct segment 12.

The condenser 19 of an air conditioner 20 is situated in the air flow duct, upstream from the cooler 10.

As shown diagrammatically in FIGS. 1 and 2, the air conditioner 20 comprises a variable-capacity piston compressor 21, the condenser 19, an expander 22, and an evaporator 23, which are connected together in pairs in that order by tubes 24 for transporting a refrigerant fluid around a closed circuit.

The evaporator 23 is disposed in the cabin 25 of the helicopter 11 to cool the air contained in the cabin.

A programmable electronic device 26 is programmed in accordance with the invention to control the air conditioner 20.

For this purpose, the device 26 is connected (cf. FIG. 1) by connections 27 to a member 28 for setting a setpoint temperature for the air in the cabin (e.g. a potentiometer or the equivalent), and also to a sensor 29 for measuring the temperature of the air in the cabin.

In accordance with an aspect of the invention, the control apparatus 26 is also connected via a connection 30 to a sensor (not shown) that senses the temperature of the oil leaving the cooler 10, and it is connected by a connection 34 to an actuator integrated in the compressor 21 for the purpose of varying its capacity.

As shown in FIG. 2, the apparatus 26 (e.g. a microcontroller) is also connected to an evaporation probe 31 and to a condensation pressure probe 32 by connections 33 in order to control/regulate the air conditioner 20 in conventional manner.

As shown in FIG. 1, the apparatus 26 includes a subtracter/adder 35 that calculates the difference between the setpoint temperature coming from the member 28 and the temperature measured by the sensor 29.

This difference is applied to the input of a module 36 that incorporates a PID regulator in order to determine a condensation temperature (or pressure) setpoint that is not to be exceeded, and/or a temperature that is not to be exceeded for the oil leaving the cooler 10.

The corresponding data (or signal) that is delivered at the output from the module 36 is applied together with the data (or signal) corresponding to the measured temperature of the oil at the outlet from the cooler 10, to the inputs of a second subtracter/adder 37; this circuit outputs a data/signal corresponding to the difference between the data/signals at its inputs.

This difference is applied at an input to a second calculation module 38 incorporating a PID loop that outputs a setpoint data/signal for the capacity of the compressor 21.

The invention thus makes use of the temperature of the oil as measured at the output from the radiator 10 as input data for regulating the compressor of the air conditioner so as to decrease its power in the event of the outside air temperature being high (e.g. about 50° C. or 55° C.), thus having the effect of reducing the condensation temperature of the refrigerant, and consequently of reducing the temperature of the air at the outlet from the condenser, and thus enhancing cooling of the main gear box (MGB).

1. A method of controlling an air conditioner (20) of a rotorcraft (11) that includes a transmission lubricant cooler (10), wherein the temperature of the lubricant is monitored and the capacity of the air conditioner is decreased in the event of the lubricant temperature reaching or exceeding a determined value.

2. A method according to claim 1, in which the temperature of the lubricant is measured at the outlet from the cooler.

3. A method according to claim 1, in which the capacity of the air conditioner is limited by decreasing the volume swept per unit time by a piston compressor (21) of the air conditioner.

4. A method according to claim 1, in which the (pre)determined value is about 90° C. to about 100° C.

5. A program including code executable by a data processor unit (26) for controlling an air conditioner (20) of a rotorcraft (11), wherein the code comprises:
a first code segment for reading first data representative of the temperature of a lubricant of a transmission mechanism of the rotorcraft;
a second code segment for determining and limiting, as a function of the first data, second data representative of a capacity (or a capacity/performance) setpoint of the air conditioner; and
a third code segment for recording the second data.

6. A program according to claim 5, in which the second code segment determines the second data as a function of target capacity data determined as a function of setpoint data for an air temperature to be maintained in the rotorcraft and as a function of data representative of the air temperature as measured in the rotorcraft.

7. A program according to claim 5, in which the code includes instructions for performing proportional, integral, and/or derivative calculation to obtain output data as a function of input data, such that the data processor unit incorporates one or more P, PI, or PID regulation modules.

8. A device (26) for controlling an air conditioner (20) of a rotorcraft (11) including a cooler (10) for cooling lubricant for a transmission mechanism, the device being arranged, where appropriate, to reduce the performance of the air conditioner in order to maintain the temperature of the lubricant at the outlet from the cooler below a (pre)determined value.

9. A device according to claim 8, comprising:
a module (37) for acquiring or reading a lubricant temperature, the module being arranged to receive a signal delivered by a sensor, preferably located at the outlet from the cooler;
a calculation module (38) for determining and limiting a capacity (or capacity setpoint) of the air conditioner as a function of the temperature of the lubricant; and
a control module (38) for servo-controlling the capacity of the air conditioner to the calculated capacity.

10. A device according to claim 8, including a PID regulator (38) for determining the capacity setpoint of the air conditioner.

11. A device according to claim 8 including a PID regulator (36) for determining a capacity target for the air conditioner as a function of a setpoint for the air temperature to be maintained in the rotorcraft and as a function of the air temperature as measured in the rotorcraft.

12. A rotorcraft (11) comprising a rotor, a mechanism for driving the rotor (in rotation) , a heat exchanger (10) for cooling a lubricant for the drive mechanism (by using air) , and an air conditioner (20) including a condenser, wherein the condenser (19) is placed in a duct (12-14) for conveying air towards the heat exchanger, upstream from the heat exchanger, and including a control device (26) arranged (programmed) to limit the heating of air by the condenser in order to maintain the lubricant leaving the heat exchanger at a temperature lower than (or equal to) a (pre)determined value.

13. A rotorcraft according to claim 12, in which the condenser and the heat exchanger are disposed on top of the cabin (25) of the rotorcraft.

14. A rotorcraft according to claim 12, including a fan (16) common to the condenser and to the heat exchanger.

15. A rotorcraft according to claim 12, in which the air conditioner includes a piston compressor (21) of capacity that is variable as a function of a capacity-varying control signal, which signal is delivered by the device for controlling the air conditioner.

16. A rotorcraft according to claim 15, in which the variation in capacity is obtained by varying the stroke of the compressor piston(s)—i.e. the cylinder capacity and/or the swept volume.

17. A rotorcraft according to claim 12, including a control device compromising a cooler (10) for cooling lubricant for a transmission mechanism, the device being arranged, where appropriate, to reduce the performance of the air conditioner in order to maintain the temperature of the lubricant at the outlet from the cooler below a (pre)determined value.

18. A rotorcraft according to claim 12, comprising a program including code executable by a data processor unit, the code comprising:
a first code segment for reading first data representative of the temperature of a lubricant of a transmission mechanism of the rotorcraft;
a second code segment for determining and limiting, as a function of the first data, second data representative of a capacity (or a capacity/performance) setpoint of the air conditioner; and
a third code segment for recording the second data.
